(19) United States
(12) Patent Application Publication
(10) Pub. No.: US 2014/0083827 A1
(43) Pub. Date: Mar. 27, 2014

(54) TOUCH PANEL

(71) Applicant: SAMSUNG ELECTRO-MECHANICS CO., LTD., Gyunggi-do (KR)

(72) Inventors: Sang Hwan Oh, Gyunggi-do (KR); Jin Uk Lee, Gyunggi-do (KR); Ho Joon Park, Gyunggi-do (KR); Jang Ho Park, Gyunggi-do (KR)

(73) Assignee: SAMSUNG ELECTRO-MECHANICS CO., LTD., Gyunggi-do (KR)

(21) Appl. No.: 13/708,652

(22) Filed: Dec. 7, 2012

(30) Foreign Application Priority Data
Sep. 21, 2012 (KR) 10-2012-0105392

(51) Int. Cl. H01H 1/06

(52) U.S. Cl. CPC H01H 1/06
USPC 200/270

(57) ABSTRACT

Disclosed herein is a touch panel including an electrode pattern configured of a combination of unit patterns in which a hole is formed at an intersection region between sides.

### CROSS REFERENCE TO RELATED APPLICATION

This application claims the benefit of Korean Patent Application No. 10-2012-0105392, filed on Sep. 21, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, according to rapid advancement of an information-oriented society, since use of computers has increasingly expanded, it is difficult to efficiently operate a product using only the keyboard and the mouse currently serving as the input device. Therefore, necessity for a device which is simple, has a less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, or a cathode ray tube (CRT) to thereby be used to allow a user to select desired information while viewing the image display device.

The touch panel is classified into a resistive type, a capacitive type, an electromagnetic type, a surface acoustic wave (SAW) type, and an infrared type. These various types of touch panels are adapted for an electronic product in consideration of a signal amplification problem, a resolution difference, the degree of difficulty of designing and processing technologies, an optical characteristic, an electrical characteristic, a mechanical characteristic, resistance to an environment, an input characteristic, durability, and economical efficiency. Currently, the resistive type touch panel and the capacitive type touch panel have been prominently used in a wide range of fields.

Meanwhile, research into a technology of forming an electrode pattern by using metal in the touch panel has been actively conducted as described in the patent document such as a prior art document below. As described above, when the electrode pattern is made of metal, electric conductivity is excellent and demand and supply is smooth. However, in the case in which the electrode pattern is made of metal, the electrode pattern should be formed in a mesh structure in a micrometer (μm) unit in order to prevent user from recognizing the electrode pattern. However, since the electrode patterns do not vertically intersect with each other in the mesh structure, an intersection region between the electrode patterns has a width larger than those of other regions, such that it is recognized by the user.

### PRIOR ART DOCUMENT

(Patent Document 1) JP2011-175967 A

### SUMMARY OF THE INVENTION

The present invention has been made in an effort to provide a touch panel capable of preventing a width of an intersection region from being larger than that of a region other than the intersection region by forming a hole at the intersection region of an electrode pattern.

According to a preferred embodiment of the present invention, there is provided a touch panel including an electrode pattern configured of a combination of unit patterns in which a hole is formed at an intersection region between sides.

The sides may intersect with each other at an angle larger than 90° or smaller than 90°.

The unit patterns may have a diamond shape.

A width of a region other than the intersection region may be constant.

The hole may have a circular shape or a polygonal shape.

The polygonal shape may be a triangular shape or a quadrangular shape.

The hole may be surrounded by the intersection region.

The touch panel may further include a transparent substrate having the electrode pattern formed thereon.

The electrode pattern may be made of copper (Cu), aluminum (Al), gold (Au), silver (Ag), titanium (Ti), palladium (Pd), chromium (Cr), or a combination thereof.

The electrode pattern may be made of metal silver formed by exposing/developing a silver salt emulsion layer.

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are plan views of a touch panel according to a preferred embodiment of the present invention;

FIG. 4 is an enlarged plan view of part X of FIG. 1;

FIG. 5 is an enlarged plan view of part Y of FIG. 2;

FIG. 6 is an enlarged plan view of part Z of FIG. 3; and

FIGS. 7 to 9 are cross-sectional views of a touch panel according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

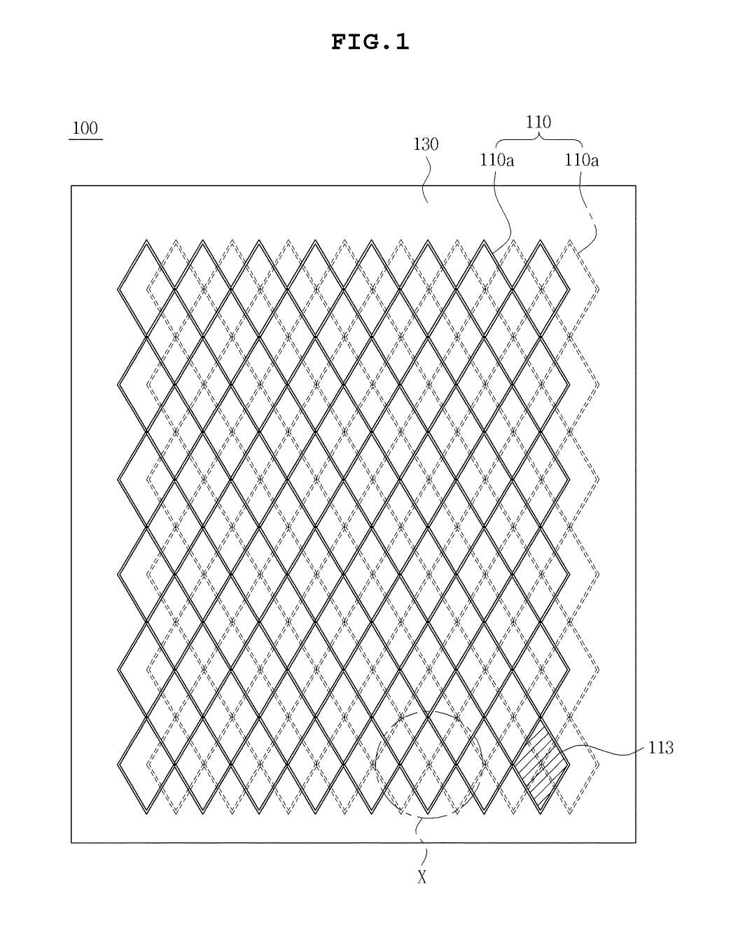

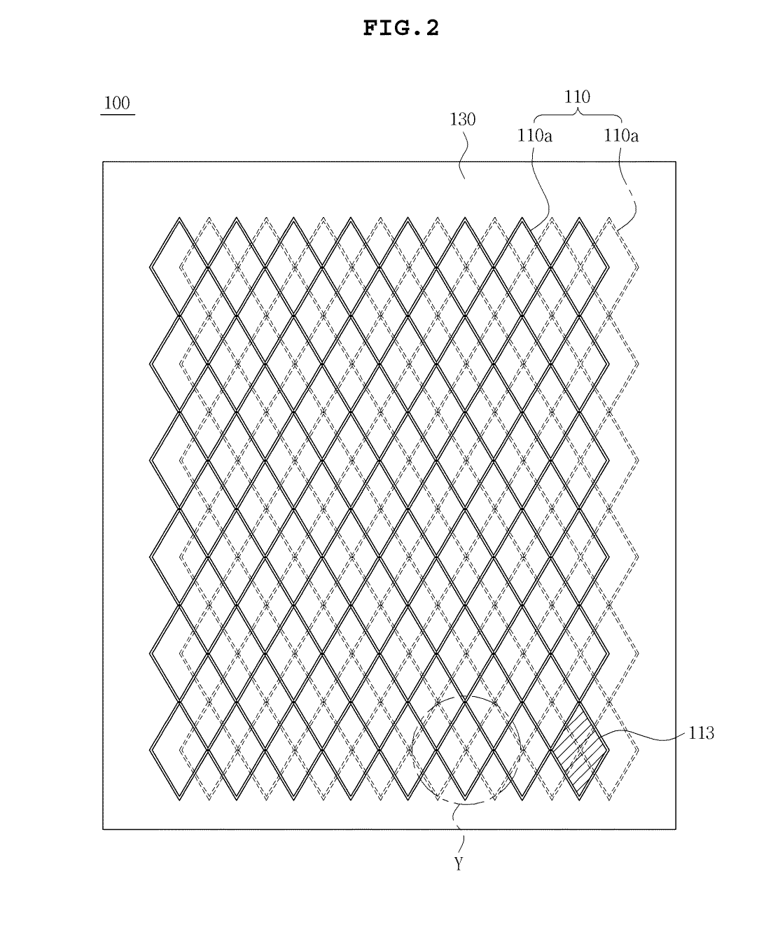

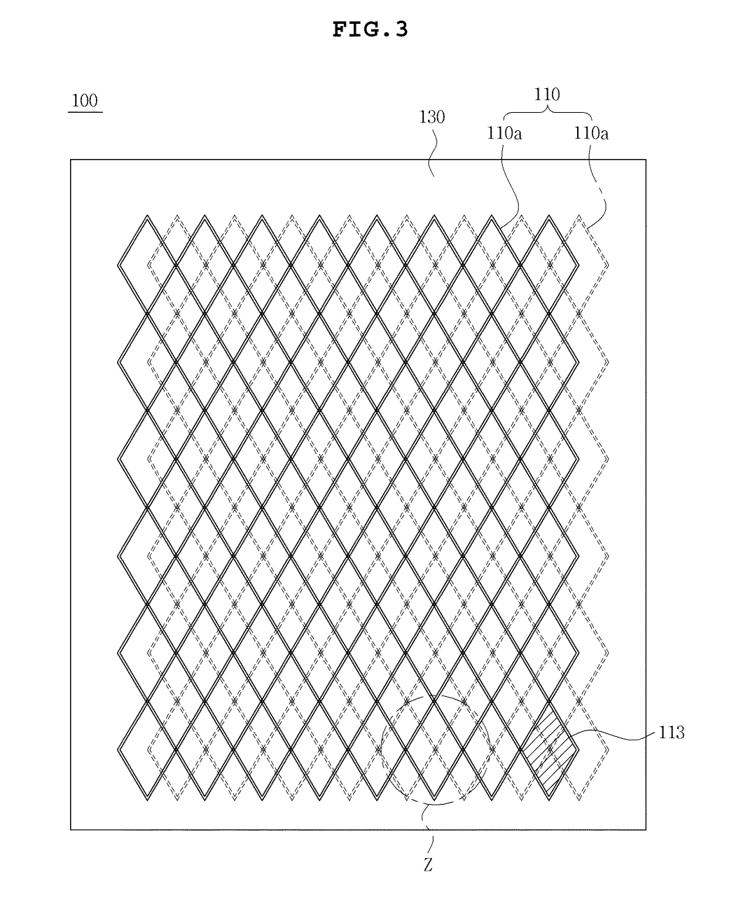

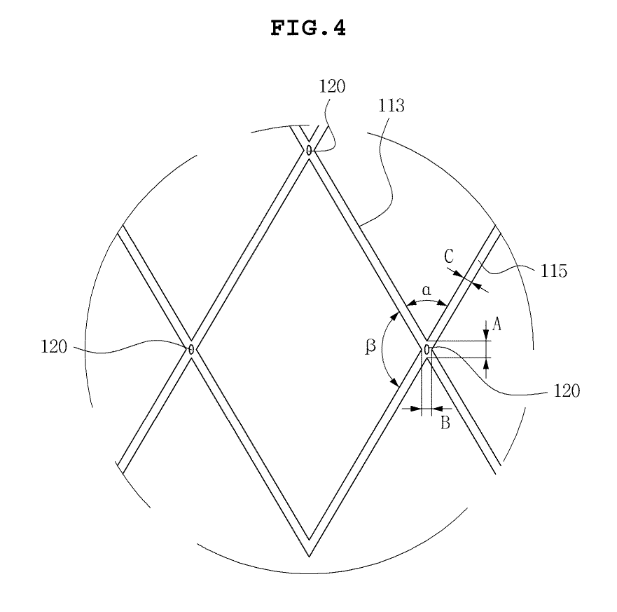

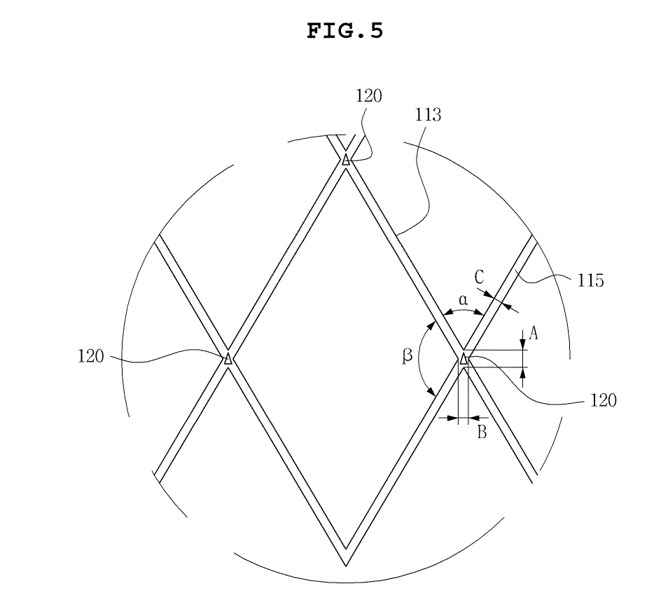

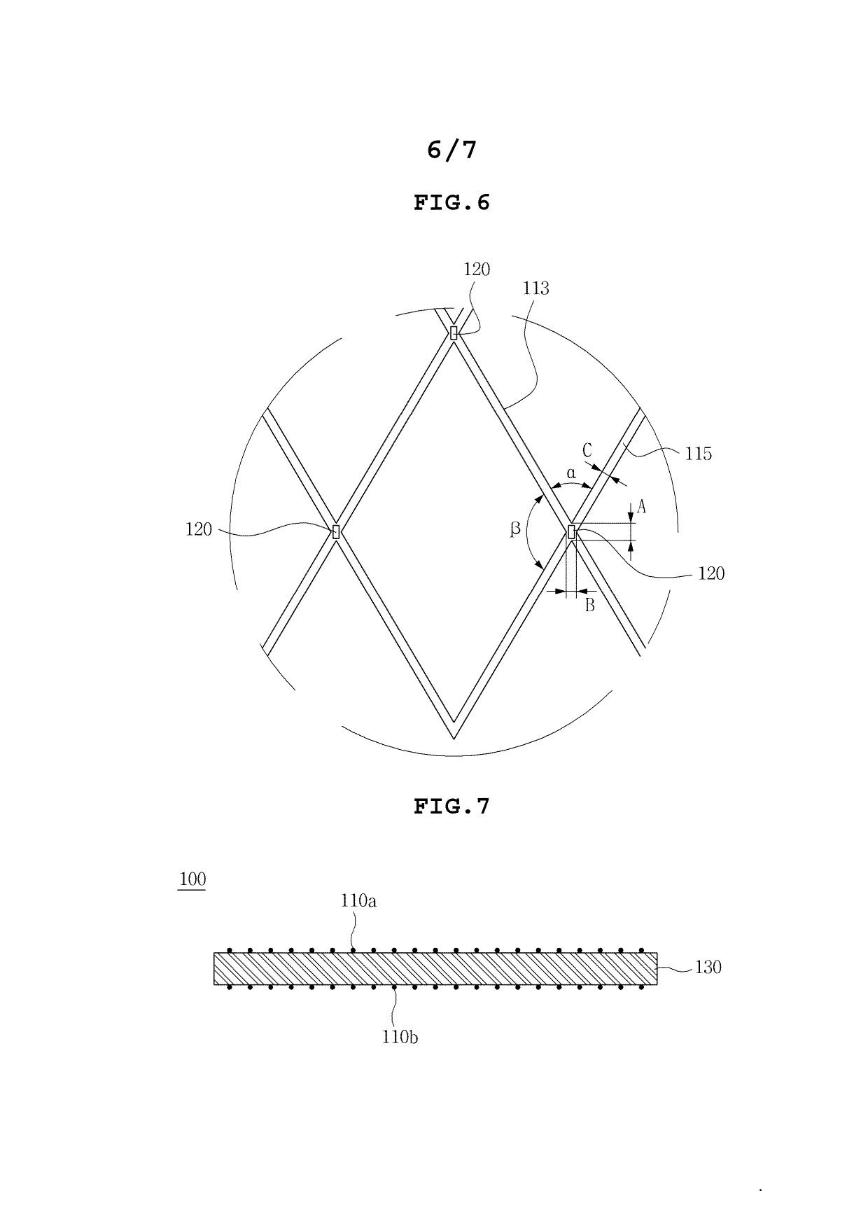

FIGS. 1 to 3 are plan views of a touch panel according to a preferred embodiment of the present invention, FIG. 4 is an enlarged plan view of part X of FIG. 1, FIG. 5 is an enlarged plan view of part Y of FIG. 2, and FIG. 6 is an enlarged plan view of part Z of FIG. 3.

As shown in FIGS. 1 to 6, the touch panel 100 according to the preferred embodiment of the present invention includes an electrode pattern 110 configured of a combination of unit patterns 113 in which a hole is formed at an intersection region between sides 115.

The electrode pattern 110 serves to allow a user to recognize touch coordinates in a controller by generating a signal at the time of touching the touch panel. Here, the electrode pattern 110 may be formed as a fine pattern in a micrometer (μm) unit using copper (Cu), aluminum (Al), gold (Au), silver (Ag), titanium (Ti), palladium (Pd), chromium (Cr), or a combination thereof. In addition, the electrode pattern 110 may include a first electrode pattern 110a and a second electrode pattern 110b. Here, the first electrode pattern 110a and the second electrode pattern 110b may be formed in a different layer. Meanwhile, the electrode pattern 110 does not necessarily include two electrode patterns (the first electrode pattern 110a and the second electrode pattern 110b), but may be configured of one electrode pattern 110. Meanwhile, the electrode pattern 110 may be formed by a plating process or a depositing process using a sputter. In addition, in the case in which the electrode pattern 110 is made of copper (Cu), a surface of the electrode pattern 110 may be black-oxide treated. Here, the black-oxide treatment 110 indicates treatment in which Cu₂O or CuO is precipitated by oxidizing the surface of the electrode pattern 110, wherein the Cu₂O is brown and is thus referred to as a brown oxide and the CuO is black and is thus referred to as a black oxide. As described above, the surface of the electrode pattern 110 is black-oxide treated to prevent light from being reflected, thereby making it possible to improve visibility of the touch panel 100. Further, the electrode pattern 110 may also be made of metal silver formed by exposing and developing a silver salt emulsion layer, in addition to the above-mentioned metals.

In addition, the electrode pattern 110 may be in a mesh structure which is a combination of a unit pattern 113 having a diamond shape, as shown in FIGS. 4 to 6. Here, sides 115 of the unit pattern 113 may usually intersect with each other at an angle larger than 90° or smaller than 90°. That is, the sides 115 of the unit pattern 113 may usually intersect with each other at an acute angle (α) or an obtuse angle (β). As described above, in the case in which the sides 115 of the unit pattern 113 intersect with each other at an acute angle (α) or an obtuse angle (β), a width of the intersection region between the sides 115 is larger than that of the region other than the intersection region. More specifically, when comparing a vertical width A, a horizontal width B, and a width C of the side 115 of the intersection region (see. FIG. 4) with each other, the vertical width A is larger than the horizontal width B, and the horizontal width B is larger than the width C of the side 115 of the intersection region (A>B>C). Here, since the vertical width A and the horizontal width B correspond to the width of the intersection region, and the width C of the side 115 corresponds to the width of the region other than the intersection region, it may be appreciated that the width of the intersection region is larger than that of a region other than the intersection region. Therefore, the intersection region may be recognized by users as compared to the region other than the intersection region. However, in the touch panel 100 according to the present embodiment, the hole 120 is formed at the intersection region to thereby significantly decrease the width of the intersection region, thereby making it possible to prevent the width of the intersection region from being larger than that of the region other than the intersection region. Here, the hole 120 may have a circular shape (see FIG. 4); however, the present invention is not limited thereto. For example, the hole 120 may have a polygonal shape including a triangular shape (see FIG. 5) or a quadrangular shape (see FIG. 6). In addition, a position of the hole 120 is not particularly limited. However, the hole 120 may be surrounded by the intersection region. Meanwhile, in order to prevent a specific portion from emerging and being recognized by the user in a region other than the intersection region, a width of the region other than the intersection region (a width C of the side 115) may be constant.

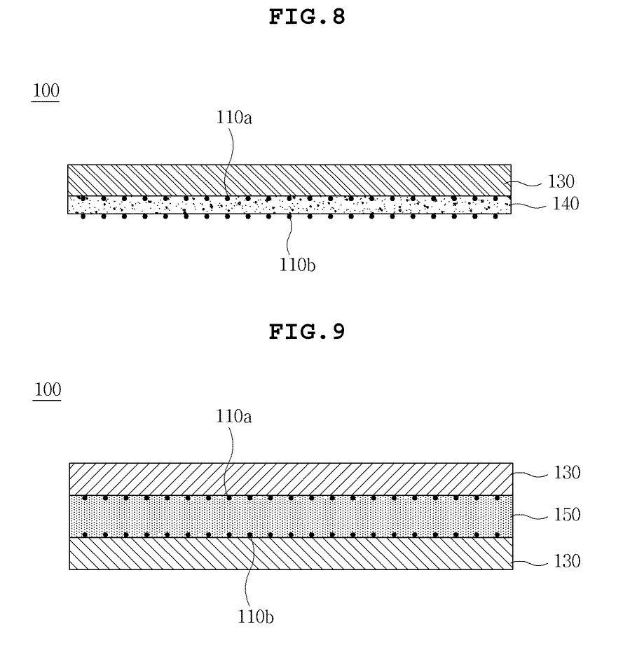

In addition, FIGS. 7 to 9 are cross-sectional views of a touch panel according to the preferred embodiment of the present invention. As shown in FIG. 7, the touch panel 100 according to the present embodiment may include a transparent substrate 130 having the first electrode pattern 110a formed on one surface and having the second electrode pattern 110b formed on the other surface. Here, the transparent substrate 130 provides a region at which the first and second electrode patterns 110a and 110b will be formed. Meanwhile, the first electrode pattern 110a and the second electrode pattern 110b are not necessarily formed on both surfaces of one transparent substrate 130, respectively. That is, as shown in FIG. 8, after the first electrode pattern 110a is formed on the transparent substrate 130, an insulating layer 140 may be formed on the transparent substrate 130 and the second electrode pattern 110b formed on the insulating layer 140. In addition, as shown in FIG. 9, two transparent substrates 130 may be provided with the first electrode pattern 110a and the second electrode pattern 110b formed on two transparent substrates 130, respectively. In this case, two transparent substrates 130 may be adhered to an adhesive layer 150. Meanwhile, the transparent substrate 130 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto. In addition, a high frequency treatment or a primer treatment may be performed on the transparent substrate 130 so as to improve adhesion between the transparent substrate 130 and the electrode pattern 110.

In addition, an electrode wiring transmitting/receiving an electrical signal from the electrode pattern 110 may be formed at an edge of the electrode pattern 110. Here, the electrode wiring may be integrally formed with the electrode pattern 110 to simplify a manufacturing process and reduce a lead time. In addition, since the electrode wiring and the electrode pattern 110 are integrally formed, a bonding process of the electrode wiring and the electrode pattern 110 may be omitted. Therefore, it is possible to previously prevent steps or bonding defects between the electrode wiring and the electrode pattern 110.

According to the present invention, the hole is formed at the intersection region of the electrode pattern to prevent the width of the intersection region from being larger than that of the region other than the intersection region, thereby making it possible to prevent the intersection region from being recognized by the user.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising an electrode pattern configured of a combination of unit patterns in which a hole is formed at an intersection region between sides.

2. The touch panel as set forth in claim 1, wherein the sides intersect with each other at an angle larger than 90° or smaller than 90°.

3. The touch panel as set forth in claim 1, wherein the unit patterns have a diamond shape.

4. The touch panel as set forth in claim 1, wherein a width of a region other than the intersection region is constant.

5. The touch panel as set forth in claim 1, wherein the hole has a circular shape or a polygonal shape.

6. The touch panel as set forth in claim 5, wherein the polygonal shape is a triangular shape or a quadrangular shape.

7. The touch panel as set forth in claim 1, wherein the hole is surrounded by the intersection region.

8. The touch panel as set forth in claim 1, further comprising a transparent substrate having the electrode pattern formed thereon.

9. The touch panel as set forth in claim 1, wherein the electrode pattern is made of copper (Cu), aluminum (Al), gold (Au), silver (Ag), titanium (Ti), palladium (Pd), chromium (Cr), or a combination thereof.

10. The touch panel as set forth in claim 1, wherein the electrode pattern is made of metal silver formed by exposing/developing a silver salt emulsion layer.
